(19) United States
(12) Patent Application Publication
(10) Pub. No.: US 2013/0028732 A1
(43) Pub. Date: Jan. 31, 2013

(54) ROLLING BEARING DEVICE HAVING A HYDRAULIC DAMPING DEVICE

(71) Applicants: Eduard Golovatai-Schmidt, Hemhofen (DE); Kurt Kirsten, Herzogenaurach (DE)

(72) Inventors: Eduard Golovatai-Schmidt, Hemhofen (DE); Kurt Kirsten, Herzogenaurach (DE)

(73) Assignee: SCHAEFFLER TECHNOLOGIES AG & CO. KG, Herzogenaurach (DE)

(21) Appl. No.: 13/640,370

(22) PCT Filed: May 2, 2011
(86) PCT No.: PCT/EP11/56894

§ 371 Date: Oct. 10, 2012

(30) Foreign Application Priority Data
May 6, 2010 (DE) 102010019528.6

(51) Int. Cl. F04D 29/049; F16C 27/04

(52) U.S. Cl. 415/229; 384/581

(57) ABSTRACT

A roller bearing device in particular in a turbocharger having a housing component having a bearing hole having an inner circumference and a rolling bearing received therein on an outer race having an outer circumference. In order to implement a component such as a rotor assembly of a turbocharger that can rotate on the inner circumference with great smoothness and that is protected against imbalance, a hydraulic damping device made of reservoirs filled with a hydraulic fluid and alternating along the circumference facing the outer periphery and the inner periphery is provided in an annular gap between the outer periphery of the outer race and the inner periphery of the bearing hole by radially pretensioning the outer race relative to the bearing hole.

### FIELD OF THE INVENTION

The invention concerns a rolling bearing device particularly in a turbocharger comprising a housing component comprising a bearing bore comprising an inner periphery and a rolling bearing received radially elastically in said bore on an outer ring comprising an outer periphery.

### BACKGROUND

Turbochargers are known in the form of exhaust gas turbochargers for enhancing the performance of internal combustion engines by increasing the throughput of the fuel mixture in the combustion chambers of the internal combustion engines. In such turbochargers, for example, a turbine locked in rotation with a compressor is driven by the exhaust gas of the internal combustion engine and said compressor increases the gas pressure of the fuel mixture in the intake tract of the internal combustion engine. The running parts of the turbocharger—generally the compressor, the turbine and the rotor shaft—are frequently slide-mounted for sliding relative to a housing component of the turbocharger in a bearing bore. By reason of the friction of such sliding bearings, the response behavior of the turbocharger is restricted.

DE 10 2008 020 067 A1 discloses a turbocharger comprising a rolling bearing device. In this turbocharger, the running part is received for rotation relative to the housing component with help of a rolling bearing. This enables a substantial reduction of the friction and thus also of the breakaway forces of the running part as well as higher accelerations. Due to the unbalanced mass of the running part, however, high loads are produced on the rolling bearing, these loads being counteracted through a clearance arranged between the outer ring of the rolling bearing and the bearing bore, into which clearance a hydraulic fluid is pressed to produce a lubricating film.

### SUMMARY

The object of the invention is the advantageous development of rolling bearing devices and turbochargers of the pre-cited type with an improved damping of the unbalanced mass of the masses, such as the running parts of turbochargers, which rotate relative to the housing component. Substantially, this is to be achieved with adherence to the existing structure and design of a rolling bearing device and of a turbocharger comprising this device.

The invention achieves the above object with a rolling bearing device particularly in a turbocharger comprising a housing component comprising a bearing bore comprising an inner periphery and a rolling bearing received in said bearing bore on an outer ring comprising an outer periphery, wherein, in case of a radial elastic bracing of the outer ring in the bearing bore, a hydraulic damping device is formed on an annular gap between the outer periphery of the outer ring and the inner periphery of the bearing bore out of beads filled at least partially with a hydraulic fluid and arranged along the periphery to alternatively face the outer periphery and the inner periphery.

Due to the division of the annular gap into a plurality of beads distributed on the periphery, the influence of the viscosity of the hydraulic fluid contained in these beads is enhanced, so that a displacement of the outer ring relative to the bearing bore taking place under radial biasing is hydraulically damped. In this way, through a choice of the cross-sections of the beads and of the biasing force, a further damping region optimized for use can be realized.

In this connection, it has proved to be particularly advantageous for obtaining the desired cross-sections of the beads and the radial biasing force, to use a single component in the form of an ondular bushing elastically braced in the annular gap. Through a choice of the number and shape of the undulations of the ondular bushing distributed along the periphery and of their material thickness and the like, the properties of the damping device with regard to radial rigidity and damping ability can be adjusted over a large range for a given annular gap. If necessary, as a further measure, the annular gap can be widened or narrowed.

The supply of hydraulic fluid is realized through at least one aperture disposed on the inner periphery of the bearing bore. For instance, an approximately centrally positioned bore can be used for this purpose. Alternatively, or additionally, further apertures can be arranged in the front end regions of the ondular bushing. Advantageously, according to the invention, the hydraulic fluid is compressed, for instance, with help of a hydraulic pump and pressed through the at least one aperture. The admission pressure thus set can be stabilized with help of a one-way valve, so that, in case of a pressure loading of the beads, a return flow during any occurring low pressure phases is excluded. Alternatively, it is also possible to maintain an adequately high counter pressure.

The beads are at least partially filled and flushed-through by the pressure input of the hydraulic fluid, so that, for a given viscosity of the hydraulic fluid, a hydrodynamic resistance is produced through the cross-section of the beads and their length, and this resistance damps the radial movements of the outer bushing caused by elastic bracing of the ondular bushing in the presence of an unbalanced mass of the running part. Each of the beads comprises a connection to the at least one aperture in the inner periphery of the bearing bore as well as a front-end discharge and/or further comprises a connection to at least one aperture in the outer ring through which the rolling elements of the rolling bearing are lubricated with a hydraulic fluid like, for instance, oil.

The inlet apertures from the bearing bore to the beads, the outlet apertures from the beads to the inner space of the rolling bearing and/or the front ends of the beads can comprise a flow-restriction feature, for example, by being configured as diaphragms or slots, so that the damping effect, i.e. the reduction of pressure in the beads upon a compression of the beads through elastic bracing of the ondular bushing takes place with a time lag. For this purpose, it is possible to provide on the beads facing the outer periphery, at least one aperture arranged opposite the inner periphery of the bearing bore. Moreover, it is also possible to provide, on at least one axial front end of at least one bead, a gap formed with help of a hump made integrally in the ondular bushing. This hump configures a narrow flow cross-section and closes the bead at least partially. For conveying the hydraulic fluid, for instance from an aperture in the bearing bore to an aperture, like a through-cut, in the outer ring, the outer periphery of the outer ring can possess appropriate profiles.

The radial rigidity of the beads, or bead walls, is configured depending on the expected unbalanced mass of the running part and the then occurring radial forces, and the damping effect of the damping device is set through a matching of the hydrodynamic flow resistance, so that an axis of a moment of inertia of a component of the rolling bearing arrangement rotating together with an inner ring of the rolling bearing, such as a running part in the turbocharger, is elastically positioned with help of the ondular bushing on the axis of rotation of the component.

The object of the invention is achieved in a similar manner with a turbocharger comprising a housing component comprising a bearing bore and a rolling bearing device for receiving a running part for rotation relative to the housing component, a rolling bearing being received radially elastically in the bearing bore with help of an outer ring, and the running part being received on an inner ring, an annular gap being arranged between an inner periphery of the bearing bore and an outer periphery of the outer ring, and an ondular bushing being radially elastically braced in said annular gap. Due to the radially elastic reception of the running part on the housing component, a turbocharger of this type can compensate for unbalanced masses of the running part in a wide range, and due to the hysteresis of the elastic deformation it can also realize an advantageous damping effect. In particular, by filling hydraulic fluid into the beads which are formed along the periphery to alternately face the outer periphery and the inner periphery, this damping effect can be enhanced through a hydraulic damping, like hydrodynamic damping, with help of a flow resistance.

### BRIEF DESCRIPTION OF THE DRAWINGS

A preferred form of embodiment of the rolling bearing configured according to the invention will be described more closely in the following with reference to the appended drawings.

FIG. 1 shows a section through a turbocharger comprising a rolling bearing arrangement comprising a rolling bearing received radially elastically on a bearing bore,

FIG. 2 shows a sectional, three-dimensional view of the rolling bearing of FIG. 1,

FIG. 3 shows a sectional, three-dimensional view of the rolling bearing of FIG. 1 taken along a different sectional line from FIG. 3, and

FIG. 4 shows a view of the ondular bushing of FIGS. 1 to 3.

### DETAILED DESCRIPTION OF THE PREFERRED EMBODIMENTS

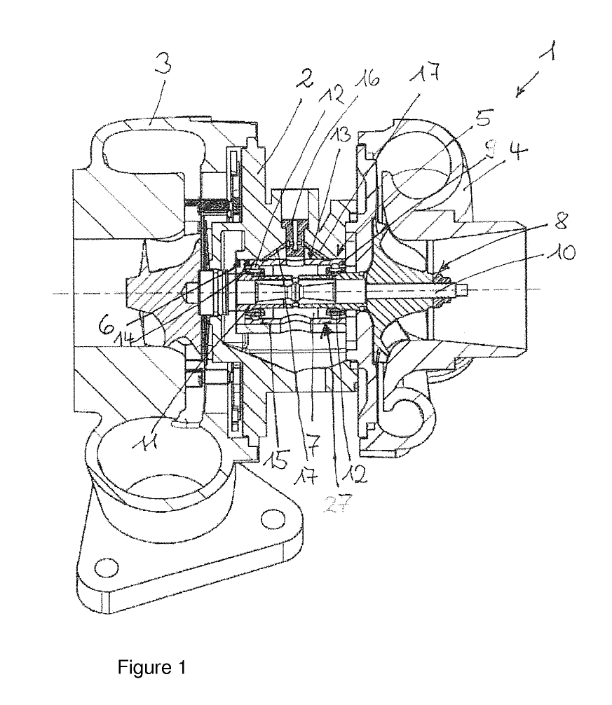

FIG. 1 shows the turbocharger 1 with the housing component 2 that serves as a bearing housing, and with the compressor housing 3 and the turbine housing 4. The housing component 2 comprises the rolling bearing arrangement 5 with the rolling bearing 7 received radially elastically in the bearing bore 6 for a rotary mounting of the running part 8. The inner ring 11 of the rolling bearing 7 is rotatable on the outer ring 9 through the double row rolling elements 12 and receives the rotor 10 of the running part 8, and the outer ring 9 is received radially elastically on the housing component 2 with help of the ondular bushing 15 arranged between the outer periphery 13 of the outer ring 9 and the inner periphery 14 of the bearing bore.

Through the throttle 16 and the fluid bores 17, the rolling bearing arrangement 5 is supplied with hydraulic fluid that is pressed through beads, not visible in this illustration, of the ondular bushing 15. As a result of this, in addition to the elastic connection, the hydraulic damping device 27, which damps the axial displacement of the rolling bearing 7 relative to the housing component 2, is formed between the outer ring 9 and the bearing bore 6 by the hydraulic fluid that is conducted with narrow flow cross-section within the ondular bushing 15. In this way, on the one hand, the running part 8 is mounted radially restrictedly elastically, for rotation relative to the housing component 2 and, on the other hand, the restricted radial movement is damped through the action of the hydraulic damping device 27.

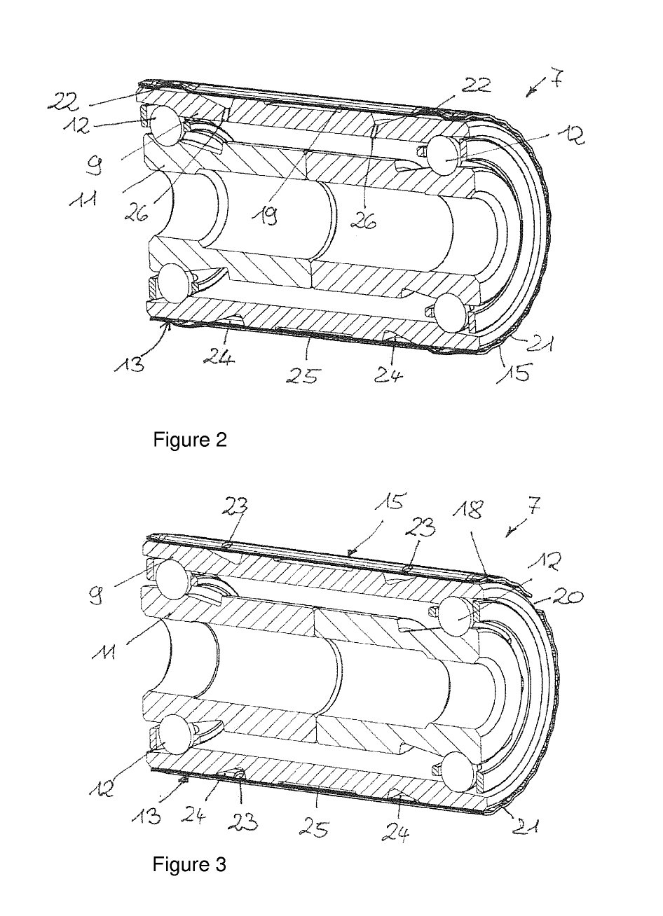

FIGS. 2 and 3 show the rolling bearing 7 of FIG. 1 in sections taken along different sectional lines, the outer ring 9 and the divided inner ring 11 as also the rolling elements 12 arranged in two rolling bearing rows. The ondular bushing 15 is pushed on to the outer periphery 13 of the outer ring 9 under biasing. For this purpose, the ondular bushing 15 comprises the longitudinal slit 20. The ondular bushing forms beads 18 that are distributed over the periphery and are open towards the inside to face the outer periphery in alternation with beads 19 that are open towards the outside to face the inner periphery 14 of the bearing bore 6 (FIG. 1). The beads 18, 19 receive hydraulic fluid through the fluid bores 17 and create a flow resistance in the empty space defined by these, so that upon elastic displacement of the ribs 21 that form the beads 18, 19, a hydraulic damping is created. For this purpose, the in-flow and/or out-flow of the hydraulic medium out of the beads 18, 19 takes place with a restricted flow.

At least some of the beads 19 facing the inner periphery 14, and thus also facing the fluid bores 17 (FIG. 1), comprise a hump 22 that is formed integrally in the ondular bushing 15 and comes to bear against the inner periphery 14. Each of the humps 22 produces a flow resistance on a front end of a respective inner space of the beads 19 which is defined by the inner periphery 14, so that hydraulic fluid can exit out of the ondular bushing 15 with a restricted through-flow at the front ends of the ondular bushing 15.

The beads 18 facing the outer periphery 13 are supplied with hydraulic fluid through the throttle openings 23 that communicate with the fluid bores 17. For increasing the volume of the beads 18, continuous annular grooves 24, 25 are provided in the outer periphery 13 of the outer ring 9, the annular grooves 24 being arranged in axial direction on the same level as the throttle openings. For cooling the rolling elements 12 and the running surfaces for these, a through-cut 26 through the outer ring 9 is arranged offset in peripheral direction to each of the throttle openings 23 on the annular grooves 24. These through-cuts 26 preferably possess a higher flow resistance than the throttle openings 23, so that the beads 18 remain filled due to the pressure differential formed.

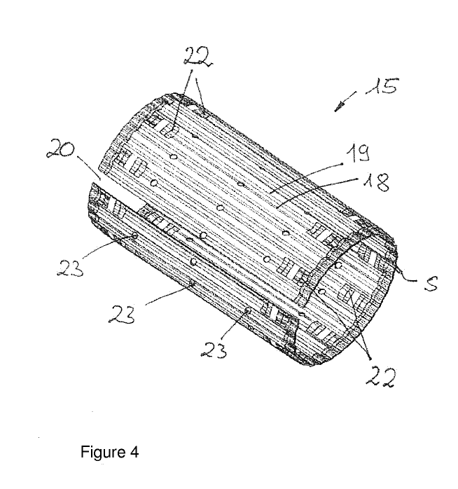

FIG. 4 shows a view of the ondular bushing 15. The material thickness s and the number of alternating beads 18, 19 provided on the periphery determine the width of the beads and serve to set the radial rigidity of the ondular bushing 15. The longitudinal slit 20 enables a biased pushing on to the outer ring 9 (FIG. 2). The adjustment of the damping effect of the ondular bushing 15 is realized by adjusting the flow resistance in the beads 18, 19. For this purpose, in accordance with their desired radial rigidity or elasticity, the number of the beads 18, 19, the number and opening cross-sections of the throttle openings 23 that determine the through-flow through these and the number of the humps 22 that adjust the opening cross-sections to the inner periphery 14 of the bearing bore 6 (FIG. 1) are defined.

### LIST OF REFERENCE NUMERALS

1 Turbocharger

2 Housing component

3 Compressor housing

4 Turbine housing

5 Rolling bearing device

6 Bearing bore

7 Rolling bearing

8 Running part

9 Outer ring

10 Rotor

11 Inner ring

12 Rolling elements

13 Outer periphery

14 Inner periphery

15 Ondular bushing

16 Throttle

17 Fluid bore

18 Bead

19 Bead

20 Longitudinal slit

21 Rib

22 Hump

23 Throttle opening

24 Annular groove

25 Annular groove

26 Through-cut

27 Damping device

s Material thickness

1. A rolling bearing device comprising a housing component including a bearing bore having an inner periphery and a rolling bearing received in said bore on an outer ring comprising an outer periphery, a hydraulic damping device is located in an annular gap between the outer periphery of the outer ring and the inner periphery of the bearing bore, the hydraulic damping device is formed out of beads filled at least partially with a hydraulic fluid and arranged along the periphery to alternatively face the outer periphery and the inner periphery.

2. A rolling bearing device according to claim 1, wherein the beads are formed by an ondular bushing that is elastically braced in the annular gap.

3. A rolling bearing device according to claim 2, wherein at least one fluid bore for the hydraulic fluid is arranged on the inner periphery of the bearing bore.

4. A rolling bearing device according to claim 3, wherein the at least one bead facing the outer periphery comprises at least one throttle opening arranged opposite the inner periphery of the bearing bore.

5. A rolling bearing device according to claim 1, wherein the outer ring comprises at least one through-cut for the hydraulic fluid.

6. A rolling bearing device according to claim 2, wherein at least one of the beads on at least one axial front end is at least partially closed with a hump formed integrally in the ondular bushing.

7. A rolling bearing device according to claim 1, wherein the beads are configured radially elastically.

8. A rolling bearing device according to claim 1, wherein an axis of a moment of inertia of a component that rotates together with an inner ring of the rolling bearing is positioned elastically on an axis of rotation of said component with help of the ondular bushing.

9. A turbocharger comprising a housing component including a bearing bore and a rolling bearing device for receiving a running part for rotation relative to the housing component, a rolling bearing being received radially elastically in the bearing bore via an outer ring thereof, and the running part being received on an inner ring, an annular gap is arranged between an inner periphery of the bearing bore and an outer periphery of the outer ring, and an ondular bushing is braced radially elastically in said annular gap.

10. A turbocharger according to claim 9, wherein beads filled at least partially with a hydraulic fluid and arranged along a periphery to alternatively face the outer periphery and the inner periphery are formed by the ondular bushing.
